(19) United States
(12) Patent Application Publication
(10) Pub. No.: US 2004/0167990 A1
(43) Pub. Date: Aug. 26, 2004

(54) Methods and apparatus for network time synchronization

(76) Inventor: Francis Wayne Peer, Aldie, VA (US)

Correspondence Address: Leonard C. Suchyta, c/o Christian R. Andersen, Verizon Services Group, 600 Hidden Ridge Drive, Mail Code: HQE03H01, Irving, TX, 75038, US

(21) Appl. No.: 10/449,283

(22) Filed: May 30, 2003

Related U.S. Application Data
(60) Provisional application No. 60/449,130, filed on Feb. 21, 2003.

(51) Int. Cl. G06F 15/16

(52) U.S. Cl. 709/248

(57) ABSTRACT

Methods and apparatus for synchronizing the clocks of network elements are described. Network elements which normally run NTP have their clocks updated using NTP. Clocks of the NTP network elements use a common clock source, e.g., a clock signal obtained from a GPS satellite, to insure proper synchronization. Non-NTP network elements, i.e., network elements that are not capable of running NTP or those where NTP is not run, are updated by a host controller, e.g., a UNIX server, using TELNET. The host controller uses NTP to obtain clock timing information from the same source, e.g., GPS satellite signal, as the other NTP capable network elements. The host controller then updates the clocks of non-NTP capable network elements using TELNET. Thus, both NTP and non-NTP capable network elements are synchronized in an automated manner. Non-NTP network element time information obtained using TELNET is examined to detect clock faults.

### RELATED APPLICATIONS

The present application claims the benefit of provisional patent application S.N. 60/449,130 which was filed Feb. 21, 2003 entitled “METHODS AND APPARATUS FOR AUTOMATED SOFTWARE GENERIC INFORMATION RETRIEVAL” and is hereby expressly incorporated by reference.

### FIELD OF THE INVENTION

The present invention is directed to communication networks, and more particularly, to methods and apparatus for synchronizing time clocks maintained by different elements of a network.

### BACKGROUND OF THE INVENTION

Communications networks such as the Public Switched Telephone Network (PSTN), Internet, individual corporate LANs and WANs, etc., are an important part of today's society. Communications networks are comprised of numerous network elements, e.g., routers, telephone switches, signal transfer points, and end devices such as telephone sets or workstations.

The various network elements often interact with one another to convey signals from one location in a network to another location. As part of the communication process, signaling often occurs in specific order according to one or more communications protocols. Also, as part of the communications process time stamps, e.g., receive and/or transmit time stamps, are often added to messages or other types of signals received or transmitted by a device in a network. Such messages may be, for example, in the form of Ethernet frames, IP packets, ATM cells or a wide variety of other known formats. Depending on the communications network, as a message is transmitted from one device to another in a communications network it may accumulate a number of received and/or transmitted time stamps.

In many existing networks, the clocks of individual network devices run independently of one another. Slight differences in clock accuracy can result in discrepancies of seconds, minutes or more in relatively short order, depending on the network.

Consider the case of individual computer workstations adding transmission time stamps to E-mail messages. Over time, the computers' clocks will become unsynchronized but the inaccuracy reflected in the E-mail time stamp does not interfere with or prevent the network from continuing to transmit E-mails successfully. Similarly, telephone switches maintain billing records using time information obtained from the individual telephone switches' clocks. Small discrepancies between the telephone switch's indicated time and the real time or the time indicated by the clocks of other telephone switches normally will not prevent telephone calls from being transmitted and billed. Accordingly, in many networks, discrepancies between clocks of different network elements due to clock inaccuracies are not only commonplace but accepted as part of the nature of having independent clocks operating throughout the network.

To prevent timing errors from becoming excessive, e.g., to prevent telephone switches from indicating the wrong hour of a call, clocks maintained by individual network elements are, in many cases, manually reset on a periodic basis. For example, clocks located in individual telephone switches may be reset on a daily basis. In many cases, this involves a human administrator manually resetting the time at the telephone switch or other network device, e.g., via a local control terminal.

In order to reduce the cost of maintaining clock settings in various network elements, newer devices often support a protocol known as Network Time Protocol (NTP). NTP allows time information to be retrieved and for a device's clock to be reset remotely, e.g., via communications transmitted over the communications network. Unfortunately, many previously deployed network devices, e.g., telephone switches, routers, etc., do not support NTP.

Network elements such as routers and telephone switches represent a significant investment. Accordingly, such elements may remain in service for many years before being replaced. As a result, there are many existing networks which include network devices which support NTP and other network devices which do not support NTP.

The manual processes of resetting clocks of individual network components has proven to work successfully where, such as in the telephone call billing cases and E-mail time stamp case, a high degree of timing synchronization between the clocks of different network elements is not required.

As networks have grown in size, the need to test networks to insure that network components are operating together correctly, e.g., performing signaling in a particular sequence specified by a particular protocol, has grown in importance. Such testing becomes ever more critical as new network elements continue to be added to networks with older elements. Thus, network testing has led to a need to be able to accurately determine the time events occur at various network nodes. Such accurate timing information is needed, in many cases, to accurately determine the sequence of detected events so that it can be compared to an expected sequence of events.

Tests on networks and their elements are often performed for maintenance, upgrading purposes, etc. In order for information from different network elements and test equipment to be properly sequenced for the tests, these elements needed a common time reference.

Currently, synchronization of network clocks is accomplished by manually setting the clocks of various network elements and test equipment manually, once or twice a day. Given the distances between network elements, it is often difficult for a single individual to visit the sites of the different network elements. This complicates the clock setting process often requiring multiple people at different locations to be involved with controlling the setting of clocks in various network devices. Unfortunately, setting the clocks manually takes time and may not be accurate, particularly when different individuals are responsible for entering the updated time on different network devices.

NTP offers a solution to the manual clock setting problem in the case where network elements support NTP and running NTP does not present a problem for one or more network elements. Unfortunately, as discussed above, many networks today include one or more network devices that do not support NTP. Thus, while NTP can be used to synchronize the clocks of NTP-capable elements, in many cases this represents only a partial solution to the clock synchronization problem. Furthermore, even in the case where a network device may be NTP capable, it may not be practical to use NTP given processing or other limitations of the particular network device. Processing and/or disk resources required to run NTP may be limited particularly in cases where NTP was added to a device which was not originally intended to run NTP.

Furthermore, using NTP with an existing element for testing purposes, when the device does not use NTP during normal, e.g., non-test, conditions, decreases the reliability of the test results. Running NTP during a test may increase a device's chance of failing a test, that it might otherwise pass, as a result of the demand NTP places on the device's processing and data storage resources. Conversely, running NTP for a test on an element which does not run NTP during normal conditions, may cause the element to pass a test that it would and should have failed, e.g., connections could be kept alive by NTP requests which might have gone dormant. Accordingly, using NTP to facilitate clock synchronization for test purposes when it is not used during normal device operation can lead to faulty test results.

In view of the above discussion, it can be appreciated that there is a need for methods and apparatus for automatically synchronizing the time of network elements, preferably without the need for adding NTP to devices which do not already support it.

In addition a need to be able to set clocks without human intervention at the site of each network device who's clock is to be reset, there is also a need for methods and apparatus for discovering timing errors indicative of network device clock problems.

### SUMMARY OF THE INVENTION

The present invention is directed to methods and apparatus for monitoring, synchronizing and/or detecting faults in the clocks of network elements, e.g., routers, end nodes, telephone switches, etc. without requiring that such network elements implement NTP (Network Time Protocol). The methods and apparatus of the present invention may be used in networks where some elements support the use of NTP and other elements do not support, or normally do not run, NTP. For such devices TELNET is used by a control host to obtain time information from a device and then to synchronize the device's clock by performing an update operation if necessary. The control host, in some embodiments, generates a report on the condition of network clocks and, in the case of an error indicating a clock fault, generates one or more alarms.

In accordance with the present invention, elements of a network are synchronized in an automated manner with little or no effort, and without the need for manually setting individual network element clocks. Automated clock setting reduces errors associated with manual clock setting procedures and allows for the network element clocks to be updated more frequently than would be possible if manual clock setting was involved.

In one exemplary embodiment network elements which normally run NTP have their clocks updated using NTP. The clocks of the NTP network elements, e.g., those running NTP, use a common clock source, e.g., a clock signal obtained from a GPS satellite, to insure proper synchronization. Non-NTP network elements, i.e., network elements that are not capable of running NTP or those where NTP is not run for a particular reason, are updated in accordance with the present invention by a host controller, e.g., a UNIX server, using TELNET. The host controller uses NTP to obtain clock timing information from the same source, e.g., a GPS satellite signal, used to update the other NTP capable network elements. The host controller then updates the clocks of non-NTP capable network elements using TELNET as a function of the clock timing information obtained using NTP.

In one particular exemplary implementation, a Unix control host uses NTP and a network router to get time information from a GPS satellite. Other NTP capable elements synchronize their internal clocks in the same manner as the Unix control host or by interacting with the control host using NTP. Non-NTP elements, e.g., those network elements that are not capable of running NTP or those elements where NTP is not run for various reasons, have their clocks synchronized by the Unix control host which interacts with the elements using TELNET. In the exemplary embodiment, each element to be synchronized using TELNET is listed in a scheduler which causes their clocks to be checked and adjusted periodically, e.g., once per hour, by the host controller. The scheduler calls a timing synchronization program whenever the clock of a network element is to be updated by the host controller. The synchronization program looks up the TCP/IP address for the element to be checked and updated. This address is used to establish a TELNET session with the element to be checked and updated. Once the TELNET session is established, in the exemplary embodiment, expect-send sequences are used to communicate with the element. Element type and other information may be accessed by the synchronization program to determine how to communicate with the element and whether or not a login is required. As part of the synchronization process, the control host will login to the network element to be checked and updated. The current time is then requested from the element. The time obtained from the network element to be updated is compared to the control host time which was updated using NTP. If the network element time differs from the time maintained by the control host, further expect send sequences are used to correct the element time. This may be done by signaling a timing adjustment to be made or by resetting the element's time completely. Once any required timing correction has been made, the control host logs out from the network element and the TELNET session with the element is terminated.

The methods and apparatus of the present invention are particularly useful when different network elements need to have synchronized time clocks for network test equipment to properly interpret test results and/or implement network tests. The methods and apparatus of the present invention can also be used when testing or simply synchronizing clocks in networks which include one or more older network elements that do not support NTP but can have their clocks automatically updated in accordance with the present invention using TELNET.

In addition to achieving clock synchronization, the method of the invention provide for a synchronization information database which includes clock information and can be used to detect clock faults and/or correct, e.g., resequence, network test results based on known clock errors. In some embodiments, the database includes alarms indicating likely clock faults detected based on, e.g., large clock errors and/or a pattern of increasing clock errors associated with a particular network element. In various embodiments, the clock information database created in accordance with the invention can be accessed via the Internet, e.g., by a network administrator about to perform a test or seeking to correct the results of a previously conducted network test.

Numerous additional features, benefits and details of the methods and apparatus of the present invention are described in the detailed description which follows.

### BRIEF DESCRIPTION OF THE DRAWINGS

FIG. 1 illustrates a communications system implemented in accordance with the present invention.

FIG. 2 illustrates the communication system of FIG. 1 with the addition of arrows to show communication between various network elements.

FIG. 3 illustrates an exemplary network element information database implemented in accordance with the present invention.

FIG. 4 is a flow diagram illustrating the time synchronization method of the present invention.

FIG. 5 illustrates an exemplary network element status database implemented in accordance with the present invention.

### DETAILED DESCRIPTION

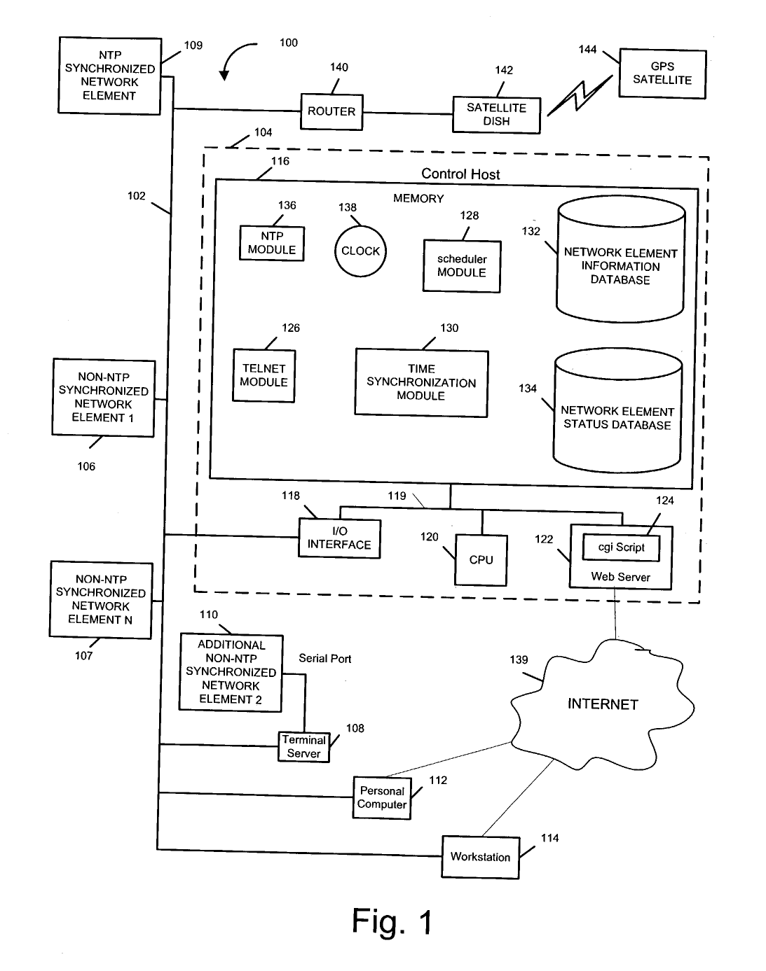

FIG. 1 illustrates an exemplary communications network 100 implemented in accordance with the present invention. Network 100 includes a variety of network elements 106, 107, 110 which do not, or can not, support NTP during operation of the network 100. Such elements are identified in the figures as “NON-NTP SYNCHRONIZED” elements. Network 100 also includes one or more network elements 104, 109 that support NTP. Since element 109 supports NTP it is identified as an NTP synchronized network element. Network elements 104, 106, 107, 109, 110 may take various forms including computers, routers, workstations, telephone switches, etc.

A communications link 102, e.g., an Ethernet or other type of communications bus, is used to couple network elements 106, 107, 109 and host controller 104 together. The link 102 also couples network elements 104, 106, 107, 109 to an additional NON-NTP synchronized network element 110 by way of a terminal server 108. Additional network element 110 may be an older device that is limited to a serial interface. Thus, while most network elements, including elements 104, 106, 107 and 109 support TELNET, terminal server 108 serves as a TELNET interface for the additional network element 110 which does not have the capability to directly support TELNET. Thus, the presence of terminal server 108 allows the additional network element 110 to receive and respond to TELNET signals, e.g., commands.

Control host 104 is used for performing network timing synchronization and various report generation features in accordance with the present invention. Control host 104 is coupled to a satellite receiver 142 by way of communications link 102 and a router coupled thereto. Satellite receiver 142 is used to recover highly accurate satellite signals from, e.g., a GPS satellite 144. While timing signals are shown being recovered from the GPS satellite 144, they may be generated by the control host 104 directly or obtained from any one of a plurality of other possible sources.

In addition to the already discussed elements, the communications system 100 includes a personal computer 112 and a workstation 114. The personal computer 112 and workstation 114 are coupled to the control host 104 via the Internet 139 as well as network 102. Thus, via the Internet 139, a person working at the personal computer 112 and/or workstation 114 can interact with the host controller 104 to obtain network device timing information, timing error reports and/or control network element timing update operations.

Control host 104 may be, e.g., a UNIX control host. The exemplary control host 104 includes memory 116, CPU 120, an Input/Output (I/O) interface 118 and a web server 122. Web Server 122 may be implemented as a software routine which, in the case of such a software implementation, the routine 122 is stored in memory 116 and is executed by CPU 122. In such a case interface 118 provides connectivity to the Internet 139 allowing the Web Server 122, when executed, to control the receipt and sending of information over the Internet 139. I/O interface 118 may be implemented, e.g., as a Network Interface Card (NIC) or modem. The various components 116, 118, 120, 122 are coupled together via a bus 119. I/O interface 118 coupled the internal components of the control host 104 the communications link 104 thereby allowing it to interact with the network elements and other devices coupled to the communications link 102. Web server 122 is used for interfacing between the control host 104 and the Internet 139 to which numerous devices, including personal computer 112 and workstation 114 are coupled.

The control host 104 manages the network elements and may be used to perform maintenance procedures such as the time synchronization operation of the present invention and report generation functions.

The CPU 120 controls operation of the control host 104 under the direction of instructions included in one or more modules stored in memory 116. Modules stored in memory 116 include a NTP module 136, a TELNET module 126, a clock module 138, a time synchronization module 130, and a scheduler module 128.

NTP module 136 supports NTP communications and control operations thereby allowing control host 104 to control one or more network elements which support NTP such as element 109, and to receive timing information there from, using NTP. TELNET module 126 supports TELNET communications. In accordance with the present invention, TELNET is used by the control host 104 to interact with network elements 106, 107, and 110 which do not support NTP. Clock module 138 is responsible for maintaining a reference clock, e.g., based on GPS timing information, that is used to synchronize the clocks of various network elements 106, 107, 109, 110.

The scheduler module 128, in some embodiments, includes information identifying the network elements which are to have their clocks synchronized and the frequency, e.g., times, at which the synchronization is to occur. For example, the scheduler 128 may schedule clock updates once each hour, a rate that would be difficult to implement if human involvement was required to update each clock of a network. ,In one exemplary embodiment, scheduler 128 is a UNIX cron scheduler.

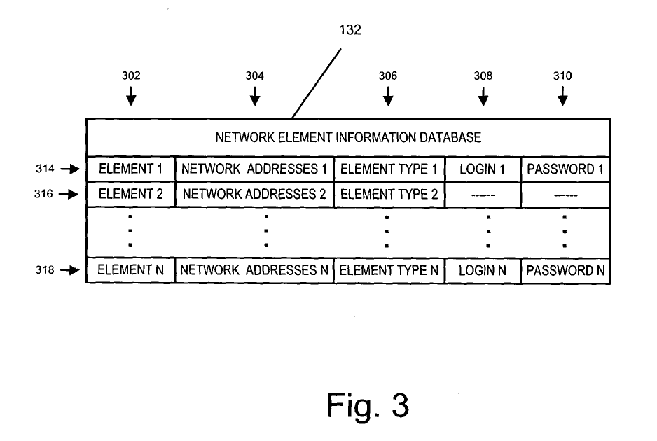

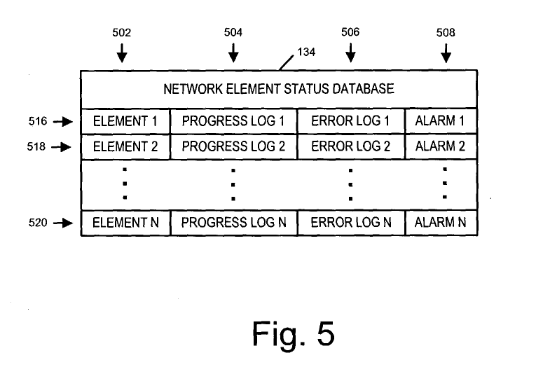

Control host 104 can also access and manipulate databases for storing relevant information such as the retrieved software generic information. Network element information database 132 stores information relating to the element, e.g., the network address of a particular device. Network element status database 134 includes information such as progress logs. Exemplary embodiments of the network element information database 132 and the network element status database 134 will be discussed later with respect to FIGS. 3 and 5, respectively.

Time synchronization module 130 is responsible for implementing the actual clock update operations using TELNET, for recovering timing information, and for generating a report which can indicate and/or may include information useful in determining, clock faults and/or network device timing errors detected by the time synchronization module 130. Network device time synchronization operations are implemented by module 130 according to the schedule specified by scheduler module 128. Schedule module 128 calls the time synchronization module 130 each time a network device is scheduled to have information updated and/or retrieved. Retrieved information relating to network devices is stored in a network element information database 132. The database 132 is accessed by the synchronization module 130 as needed, to retrieve information on whether a device to be updated is to be updated using TELNET or NTP and, in some cases, to retrieve a stored script used to perform the TELNET time update operation. Information about the current status of the network element clocks determined by synchronization module 130 is stored in network element status database 134. In accordance with the invention, the results of the time synchronization operation is made available to authorized users, e.g., on the Internet. This is achieved by making access in network element status database 134 accessible via web server 122. Web server 122, through the use of, e.g., CGI Script 124, allows the results of the timing information and clock update operations of the present invention to be accessed by authorized users, through, e.g. personal computer 112 and workstation 114.

Thus, the information in database 134 can be accessed via the Internet before or after performing a network test requiring clock synchronization or device clock timing information. Timing information in database 134 may be used to adjust test results based on known clock discrepancies. In addition, the time synchronization results in database 134 may be used to detect errant clocks in network elements, e.g., by examining the result to detect patterns of repetitive time correction that are indicative of a clock with an unusually high error rate.

In the exemplary embodiment, NTP capable network elements 109, 104 use the same time source, e.g., GPS timing information obtained from router 140. As a result, NTP network elements 109, 104 will be synchronized with each other. Non-NTP capable network elements maintain time synchronization using the TELNET based time synchronization method of the present invention.

In order for network element status database 134 to include a complete set of information on network clocks, the scheduler module 128 may trigger the time synchronization module 130 to periodically check the clocks of NTP synchronized network elements, such as elements 109, and to enter the information in the database 134. This allows an individual performing network tests, e.g., from workstation 114, to obtain a full set of clock information from a single database via the Internet. It also facilitates clock fault detection since information which may indicate a faulty clock in an NTP network element will be available from the same database which includes information useful for detecting clock faults in non-NTP network elements.

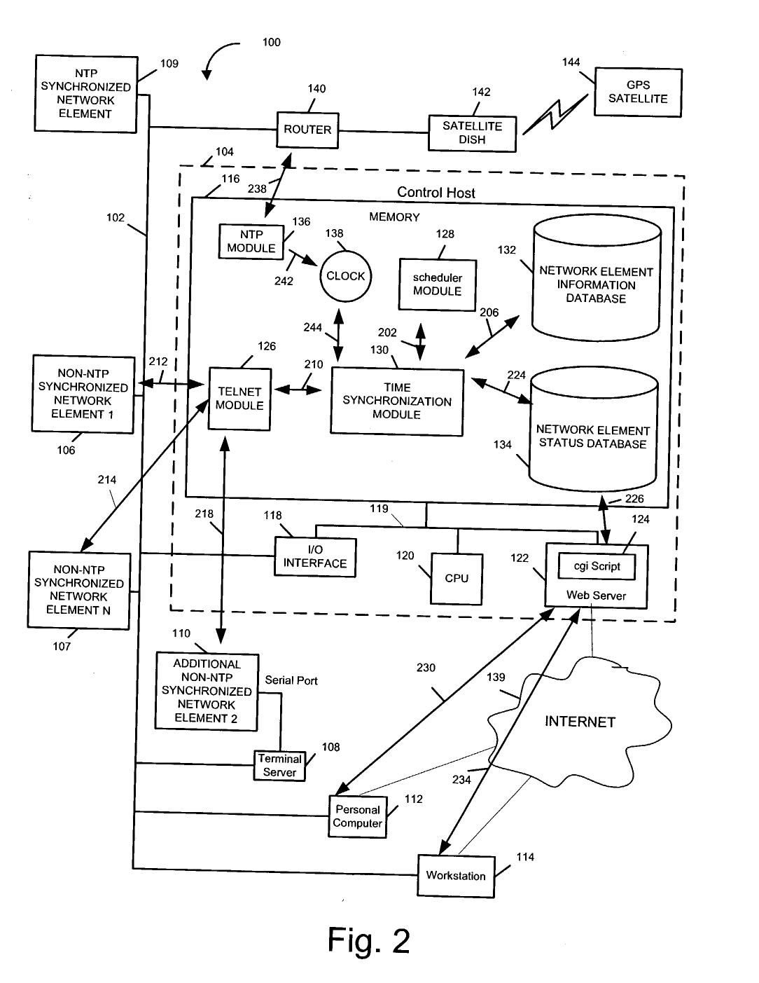

FIG. 2 illustrates the communication network 100 of FIG. 1 with arrows representing the communication between the control host 104 and various network elements and/or modules in the control host 104. Arrow 238 corresponds to communications between NTP module 136 and router 140, e.g., NTP signaling used to obtain time information from satellite receiver 142. Arrow 242 represents the communication of time information between NTP module 136 and clock 138 used to update the control host's internal clock time based on the timing information obtained by NTP module 136. Arrow 244 represents the clock 138 supplying the time synchronization module 130 with current time information to be used in updating various non-NTP network elements 106, 107, 110. Arrow 202 represents signaling between the scheduler module 128 and time synchronization module 130 used to trigger various operations by the synchronization module 130 including, e.g., updating the time of particular non-NTP network elements 106, 107. Arrows 206, 224 represent the exchange of information between time synchronization module 130 and network element information database 132 and network element status database 134, respectively. Such information exchanges may occur as part of a normal non-NTP network element time synchronization operation. Arrow 210 represents the exchange of information and other signals between TELNET module 126 and time synchronization module 130, e.g., as part of a timing synchronization operation using TELNET. Arrows 212, 214, and 218 represent communications operations implemented using TELNET with non-NTP network elements 106, 107 and 110, e.g., to check and update the clocks of these network elements in accordance with the invention. Arrows 230, 234 represent communication over the Internet used to obtain clock, timing and/or error reports generated in accordance with the invention, from web server 122.

Referring now briefly to FIG. 3, an exemplary network element information database 132 is shown. Each of the rows 314, 316, 318 of database 132 represents the stored information pertaining to a different one of the network elements. Row 314 corresponds to network element 1 106 as indicated in the first column of row 314. Row 316 corresponds to a network element 2 while row 318 corresponds to network element N 107. The columns of the database 132 include element identifiers 302, network addresses 304, network element types 306 and, optional login information 308 and passwords 310.

Network addresses 304 include, e.g., the IP address of the corresponding network element. The network element type information indicates the type of the corresponding network element, e.g., personal computer, server, etc. Login information 308 is provided where it is necessary to login to a network element to obtain and/or update clock information. For cases where a login is necessary and a password is required, password information 310 is included for the network element. From exemplary database 132, it can be seen that element 1 requires both a login and a password while element 2 requires neither.

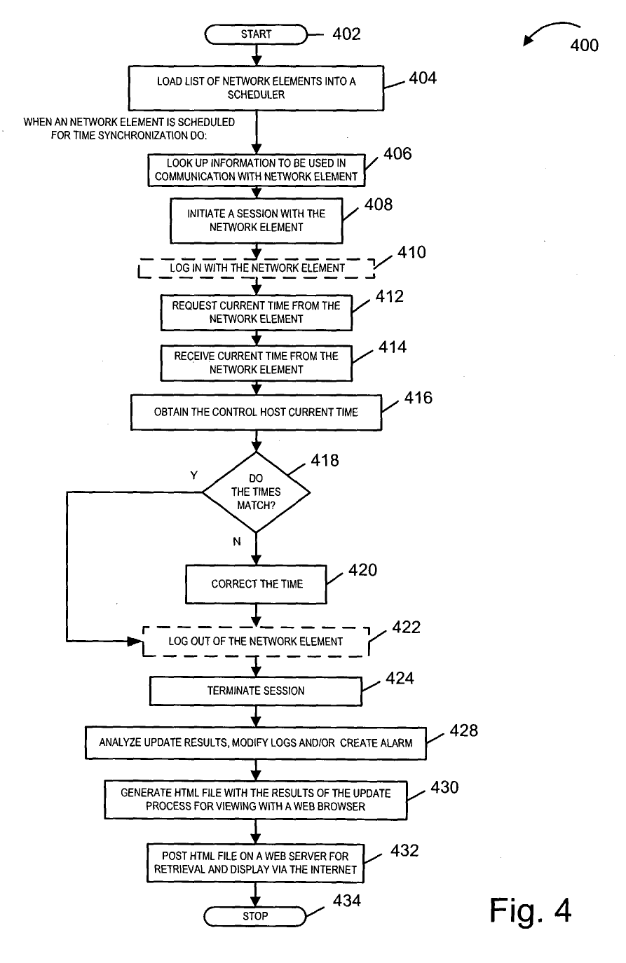

FIG. 4 shows the steps of an exemplary time synchronization method 400 of the present invention which can be implemented by the control host 104. The steps of the method 400 may be performed under direction of CPU 120 executing various modules, e.g., NTP module 136, clock 138, scheduler module 128, TELNET module 126 and time synchronization module 130.

The method 400 starts in step 402, e.g., with the system components of FIG. 1 being activated. At the time of activation, e.g., in step 402, and periodically thereafter, the control host under control of NTP module 136 obtains the current time from a GPS satellite 144 through NTP based communication with a router 140. The received time is used to set clock 138 which is then maintained using internal timing information. With the clock 138 set to the common clock signal used to update other network elements using NTP, operation proceeds to step 404 wherein a list of network elements, e.g., a list of non-NTP network elements obtained from network element information database 132 is loaded into memory and the scheduler 128 begins executing. The scheduler 128 continues to run during the entire period of time the control host 104 remains active. When a network element, e.g., non-NTP synchronized network element 1 106, is scheduled for time synchronization, the scheduler module 128 triggers the time synchronization module 130 and processing proceeds to step 406.

In step 406, processing proceeds by looking up information to be used in communication with the network element in the network element information database 132. This information may include the network address, e.g., TCP/IP address, of the network element 1 106.

The information obtained in step 406 includes the network element's network address, network element type information which may be used to determine the communication protocol (TELNET or NTP) that should be used. If a login is required, the login and password information is also retrieved from the network element information database 132.

Next, in step 408, a session is initiated with the network element using the obtained network address and indicated communications protocol. In the case of non-NTP elements 106, 107, 110 a TELNET session will be initiated. In the case of an NTP element 109, a communications session involving use of the NTP protocol will be initiated. NTP elements may or may not be included on the synchronization schedule depending on the particular implementation.

If it is determined that a login is necessary, in step 410, the control host 104 under control of the time synchronization module 130 uses the login and password information obtained from the network element information database 132 to login with the network element.

Then in step 412, e.g., using expect-send sequences, the time synchronization operation 400 proceeds to request the current time from the network element and in step 414, the current time is received by the control host 104. After the control host 104 receives the software information from the network element, in step 416, the control host obtains the current time from its clock.

In step 418 the received time from the non-NTP synchronized network element 1 106 and the current time of the control host 104 are compared. If the two times match, processing proceeds directly to step 422. If the two times do not match, processing proceeds to step 420.

In step 420 the control host under the control of time synchronization module 130 corrects the time at the non-NTP synchronized network element 1 106. Depending on the type of the network element, the time correction may be performed by a plurality of different methods. For example the control host 104 could reset the time at the network element to the synchronized time, or the control host 104 can instruct the network element to move its clock ahead a certain amount of time or set its clock back a certain amount of time. Processing proceeds from step 420 to step 422.

If no login occurred, operation will proceed from step 420 directly to step 424. However, if a login occurred, before proceeding to step 424, the control host 104 logs out of the network element. In step 424, the communications session, e.g., TELNET session, is terminated.

Operation proceeds from step 424 to step 428 wherein the control host 104 analyzes the clock discrepancy, if any, and creates and/or updates a log of update information indicating, e.g., the time the update occurred, the time indicated by the element before the update and the determined clock error. The detected clock error may be stored in a separate log file from the update information. In addition to the log update, if the determined clock discrepancy is sufficiently large to indicate a clock failure or if it is determined that the discrepancy is much larger than a previously determined clock discrepancy for the same time interval between updates, an alarm file is also generated in step 428. The log and alarm files are stored in network element status database 134.

Referring now briefly to FIG. 5, an exemplary network element status database 134 implemented in accordance with the present invention is shown. Each of the rows 516, 518, 520 of database 134, include information corresponding to a different network element. Row 516 includes information corresponding to network element 1 106. Row 518 corresponds to a second network element while row 520 corresponds to network element N 107. The columns of the database 134 include network element identifiers 502, update logs 504, error logs 506 and alarms 508.

Returning, once again to FIG. 4, from step 428 in which the logs are updated, operation proceeds to step 430. In step 430, the control host 104 prepares the updated results stored in the database 134 for viewing, e.g., using a Web browser by generating an HTML file from the updated contents of database 134. The generated HTML file is supplied, in step 430 to the Web server 122 where it can be accessed via the Internet. Alternatively, the web server 122 can access information database 134 and generate HTML pages in response to specific Internet data access attempts.

Making the results of the time synchronization method 400 available on the network and/or Internet, allows authorized users to access time synchronization information and any errors that may have occurred during a time synchronization operation. For example in FIG. 2, personal computer 112 and workstation 114 can both be used as access time synchronization information via the Internet.

Operation of time synchronization processing associated with a scheduled update stops in step 434, but the control host 104 remains active and will proceed to implement steps 406 through 434 each time the scheduler indicates that a network element clock update operation is to be performed.

The steps of the various methods of the invention discussed above may be implemented in a variety of ways, e.g., using software, hardware or a combination of software and hardware to perform each individual step or combination of steps discussed. Various embodiments of the present invention include means for performing the steps of the various methods. Each means may be implemented using software, hardware, e.g., circuits, or a combination of software and hardware. When software is used, the means for performing a step may also include circuitry such as a processor for executing the software. Accordingly, the present invention is directed to, among other things, computer executable instructions such as software for controlling a machine or circuit to perform one or more of the steps or signal processing operations discussed above.

The time synchronization operation of the present invention turns the tedious task of manually synchronizing the clocks of non-NTP network elements into an automated process that can be accomplished faster and with less error than known methods. In addition, the data obtained from repeated executions of the time synchronization operation of the present intention may be used to help maintain the network by identifying and/or assisting in the identification of faulty clocks and providing error information that can be used to resequence network test results as may be necessary, e.g., to evaluate the accuracy of test results.

It is to be understood that numerous variations on the above described methods and apparatus are possible without departing from the scope of the invention.

What is claimed is:

1. A method of synchronizing network element time clocks, comprising:
initiating a TELNET communications session with a first network element;
requesting time information from the first network element;
correcting the time of a first network element clock maintained by the first network element; and
terminating the TELNET communications session with the first network element.

2. The method of claim 1, wherein correcting the time of the clock maintained by the first network element includes:
modifying the time of the first network element clock to match the time of a control clock previously updated using Network Time Protocol signaling.

3. The method of claim 2, wherein the step of modifying the time of the first network clock includes resetting the clock to a new time.

4. The method of claim 2, wherein the step of modifying the time of the first network clock includes instructing the first network element to perform one of a clock time increment or clock time decrement operation.

5. The method of claim 2, wherein said control clock is a clock maintained by a control host device, the method further comprising:
operating the control host to update the time of said control clock using Network Time Protocol signaling.

6. The method of claim 2, further comprising:
operating a control host device to maintain a schedule for updating a plurality of network element clocks, said schedule including said first network element clock.

7. The method of claim 6, further comprising:
operating the control host to access information used to login to said first network element as part of said TELNET session, said information including a password.

8. The method of claim 7, further comprising:
operating the control host device to update the clock of a second network element using Network Time Protocol signaling.

9. The method of claim 8, wherein said information used to login to said first network element is obtained from an information database including information indicating whether TELNET or Network Time Protocol signaling is to be used to update the first and second network element clocks.

10. The method of claim 2, further comprising:
generating a file including clock update information; and
making said file accessible via the Internet.

11. The method of claim 10, further comprising:
examining time information obtained from the first network element to detect clock errors indicative of a clock failure; and
generating an alarm if a clock error indicative of a clock failure is detected.

12. The method of claim 10, further comprising the step of:
accessing said file including clock update information; and
resequencing network test results as a function of information included in said file.

13. A system for updating the clocks of network elements, the system comprising:
a control clock;
a scheduler for scheduling network element clock updates; and
a network element clock synchronization module for automatically synchronizing a clock of a first network element with said control clock using TELNET signaling when said schedule indicates said first network element clock is to be updated.

14. The system of claim 13, further comprising:
a network time protocol module for updating the time of said control clock using Network Time Protocol signaling.

15. The system of claim 14, further comprising:
a network element information database including information used to login to said first network element using TELNET, said information including a password.

16. The system of claim 15, further comprising:
means for generating a file of network element clock update information.

17. The system of claim 16, further comprising:
means for supplying information included in said file of network element clock update information to a device via the Internet.

18. The system of claim 17, further comprising:
a workstation used to perform a network test, said work station including means for receiving said network element clock update information via the Internet.

19. The system of claim 15, further comprising:
means for analyzing time information obtained from said first network element using TELNET to detect errors indicative of a clock fault.

20. The system of claim 15, wherein said schedule includes a list of network elements to be updated using TELNET and network elements to be updated using Network Time Protocol.

21. The system of claim 20, wherein said network time protocol module includes means for synchronizing a clock of a second network element with said control clock when said schedule indicates the clock of said second network element is to be updated.
